(19) United States
(12) Patent Application Publication
(10) Pub. No.: US 2007/0277419 A1
(43) Pub. Date: Dec. 6, 2007

(54) Structure of one-piece-form bezel and manufacturing method thereof

(75) Inventor: Wen-Chin Tsai, Jhubei City (TW)

Correspondence Address: ABELMAN, FRAYNE & SCHWAB, 666 THIRD AVENUE, 10TH FLOOR, NEW YORK, NY, 10017, US

(73) Assignee: JOCHU TECHNOLOGY CO., LTD.

(21) Appl. No.: 11/708,086

(22) Filed: Feb. 15, 2007

(30) Foreign Application Priority Data
Jun. 5, 2006 (TW) 95119927

(51) Int. Cl. A47G 1/10; B23P 11/00

(52) U.S. Cl. 40/785; 29/428

(57) ABSTRACT

A one-piece-form bezel and its manufacturing method are disclosed here. The present invention utilizes a frame element with a one-piece-form rivet and a frame element with and one-piece-form riveting hole to rivet frame elements with each other and to complete the assemble by punching. The present invention is not necessary to utilize extra assembling processes, such as soldering, solvent, adhesive or gluing process, to joint frame elements and is only to utilize the normal punching equipments to form the present one-piece-form bezel.

### BACKGROUND OF THE INVENTION

1. Field of the Invention

The present invention is related to the bezel of a liquid crystal display. More particularly, the present invention provides the structure of one-piece-form bezel of the liquid crystal display and its manufacturing method.

2. Description of the Prior Art

Generally, the prior bezel of the plane display is formed by directly one-step punching the metal material to form the one-piece-form bezel. Owing to the bigger size of the bezel, it needs the punching equipment and the mold with the bigger size and specification for one-step punching so as the cost will be increased because of the punching equipment and the mold. Besides, the mold is bulky, the operation is difficult and the waste material of the punching step is much. Even the structure of the one-piece-form bezel is stronger, however, the cost is corresponding increasing.

Hence, there are usually using a plurality of frame elements to constitute a rectangle bezel for fixing the panel and the metal bezel or frame of the backlight module. Referring to FIG. 1A, FIG. 1B, FIG. 1C, FIG. 1D and FIG. 1E, those are partial schematic diagrams of the bezel structure of the display panel of the Taiwan Patent Issued No. M285175. The disclosed bezel is composed of a plurality of frame elements and the rectangle bezel is having a containing space la.

Following the foregoing description, frame elements 10 are jointed with each other at the edge. At the edge of frame element, there are respectively formed a joint surface 11 of the edge of the frame element with a corresponding reduced thickness. A semicircle concave portion 11a and a protruding portion 11b are formed on the joint surface 11. Further, there are respectively corresponding arranged a mortise 12a and a tenon 12b for joint surfaces 11 to align and to tenon with each other. At the outside edge of the frame element 10, a vertical portion 13 is formed to around and to constitute a containing space 1a. In the prior art, the disclosed bezel structure must be completed by utilizing the welding step, the solvent, the adhesive or the gluing step between joint surfaces 11 to joint frame elements 10.

### SUMMARY OF THE INVENTION

In order to solve the foregoing problems, one object of the present invention is to provide the structure of a one-piece-form bezel and its manufacturing method. The bezel structure utilizes one-piece-form frame element having the rivet and the rivet hole to rivet each other and to utilize the punching step to complete the one-piece-form bezel.

Another object of the present invention is to provide the structure of a one-piece-form bezel and its manufacturing method. The present invention unnecessarily utilizes the conventional welding step, the solvent, the adhesive or the gluing step to joint frame elements but only utilizes the common punching equipments to complete the formulation of the one-piece-form bezel.

The further object of the present invention is to provide the structure of a one-piece-form bezel and its manufacturing method. While the size of the bezel becomes bigger to cause the difficulty on transporting, the design of the present one-piece-form bezel may deliver frame elements to the customer end and then perform the punching step and the joint step to assemble the one-piece-form bezel.

To achieve the foregoing purposes, one embodiment of the structure of a one-piece-form bezel of the present invention includes: at least a first frame element and at least a second frame element; a first joint portion and at least a first rivet unit arranged at the edge of the first frame element; and a second joint portion and at least a second rivet hole arranged at the edge of the second frame element. Wherein, the first rivet unit is protruded on the first joint portion; the second rivet hole is penetrated through the second joint portion; the first rivet unit of the first joint portion is corresponding penetrating the second rivet hole of the second joint portion to fill the second rivet hole so as to align and joint the first frame element and the second frame element; and a combination thickness of the first joint portion and the second joint portion is equal to the thickness of the first frame element and the second frame element.

Another embodiment of a manufacturing method of a one-piece-form bezel of the present invention includes the following steps: providing at least a first frame element; simultaneously forming a first portion and at least a first rivet unit at the edge of the first frame element, wherein the first rivet unit is protruded on the first joint portion; providing at least a second frame element; simultaneously forming a second joint portion and at least a second rivet hole at the edge of the second frame element, wherein the second rivet hole is penetrated through the second joint portion; utilizing the first rivet unit of the first joint portion to corresponding penetrate the second rivet hole of the second joint portion to align and joint the first frame element and the second frame element; and utilizing a punching step to punch the first rivet unit to fill the second rivet hole to tightly joint together with the first frame element and the second frame element.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A, FIG. 1B, FIG. 1C, FIG. 1D and FIG. 1E are partial schematic diagrams of the bezel structure of the display panel of the Taiwan Patent Issue No. M285175;

FIG. 2A, FIG. 2B, FIG. 2C and FIG. 2D are partial 3-D schematic diagrams of procedures of the manufacturing method of the one-piece-form bezel in accordance with one embodiment of the present invention;

FIG. 3A, FIG. 3B, FIG. 3C and FIG. 3D are cross-section view schematic diagrams according to FIG. 2A, FIG. 2B, FIG. 2C and FIG. 2D;

FIG. 4A is a front view schematic diagram of the one-piece-form bezel in accordance with one embodiment the present invention;

FIG. 4B is the cross-section view schematic diagram the according to FIG. 4A at the A-A cross-line;

FIG. 5A is a front view schematic diagram of the one-piece-form bezel in accordance with one embodiment of the present invention;

FIG. 5B is the schematic diagram of the cross-section view according to FIG. 5A at the B-B cross-line; and

FIG. 6 is a front view schematic diagram of the one-piece-form bezel in accordance with one embodiment of the present invention.

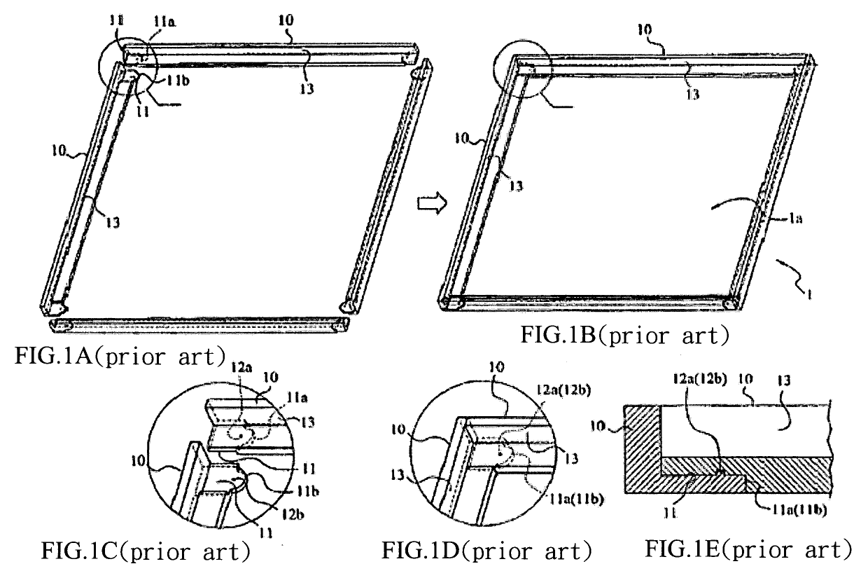

### DESCRIPTION OF THE PREFERRED EMBODIMENT

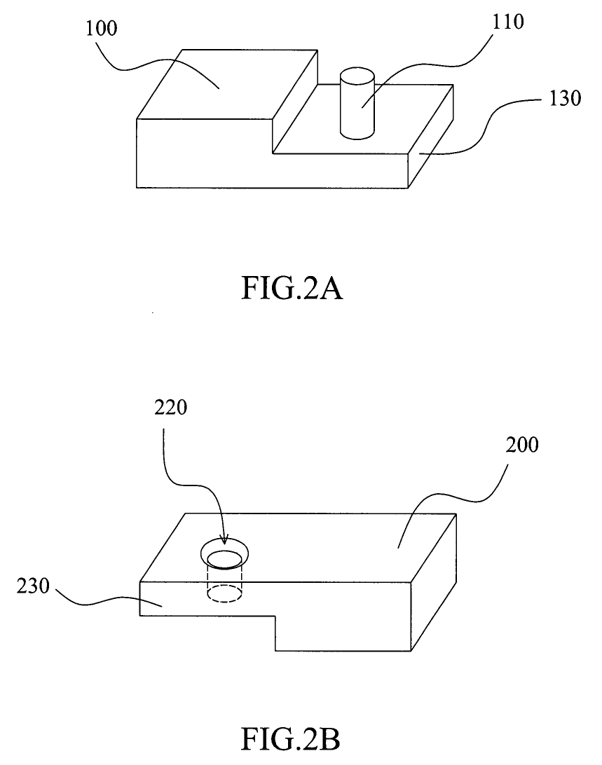

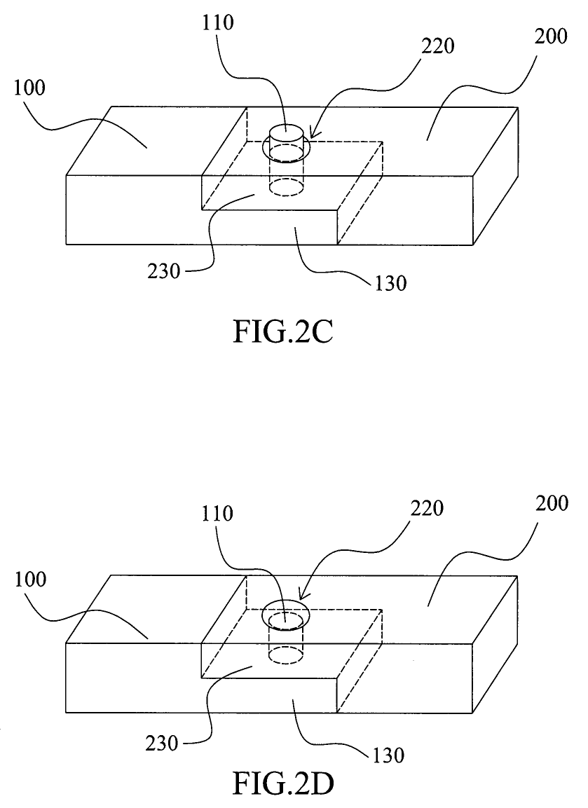

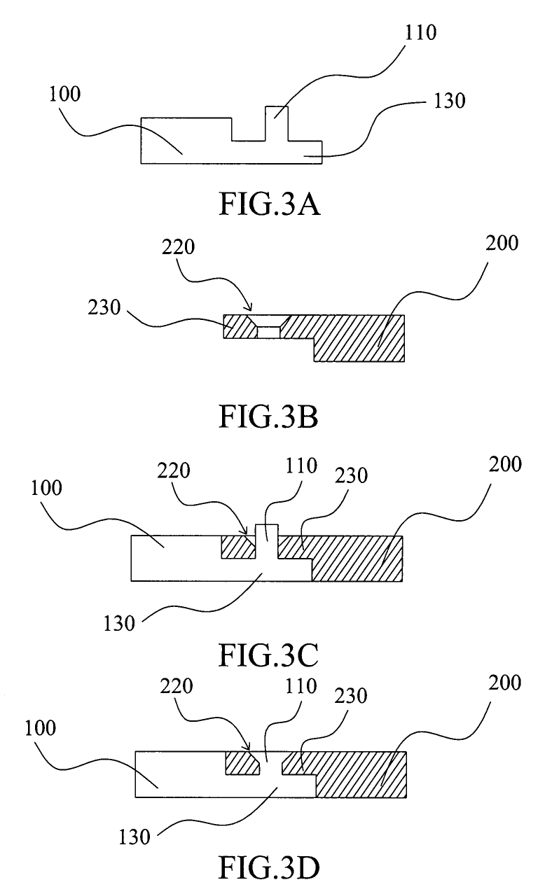

FIG. 2A, FIG. 2B, FIG. 2C and FIG. 2D are partial 3-D schematic diagrams illustrating the manufacturing method of the one-piece-form bezel in accordance with one embodiment of the present invention and FIG. 3A, FIG. 3B, FIG. 3C and FIG. 3D are cross-section view schematic diagrams according to FIG. 2A to FIG. 2D. In the present embodiment, such as shown in FIG. 2A and FIG. 3A, first, at least first frame element 100 is provided and a first joint portion 130 and at least a first rivet unit 110 are simultaneously formed at the edge of the first frame element 100. The first joint portion 130 and the first rivet unit 110 are formed by a forging step and the first rivet unit 110 is protruded on the first joint portion 130. The first frame element 100 and the second frame element 200 are made of metal material and may be any one of a strip-type flat board, a L-type flat board or a [symbol] -type flat board. Following, referring to FIG. 2B and FIG. 3B, at least a second frame element 200 is provided and a second joint portion 230 and at least a second rivet hole 220 are simultaneously formed at the edge of the second frame element 200 by a punching step. Wherein, the second rivet hole 220 is penetrated through the second joint portion 230.

To continue the above explanation and referring to FIG. 2C and FIG. 3C, in the present invention, the first frame element 100 and the second frame element 200 are aligned by jointing the first rivet unit 110 of the first joint portion 130 with the second rivet hole 220 of the second joint portion 230. Wherein, the second rivet hole 220 is in the shape of an upside wide and downside narrow hole, such as a funnel type hole. The first rivet unit 110 is jointed the second rivet hole 220 from the narrow downside to the wide upside. Then, referring to FIG. 2D and FIG. 3D, a punching step is utilized to punch the first rivet unit 110 to fill the second rivet hole 220 to tightly joint the first frame element 100 and the second frame element 200 to become one-piece-form.

Referring to FIG. 3D, the one-piece-form bezel structure formed by the foregoing method is composed of at least first frame element 100 and at least second frame element 200. The first frame element 100 and the second frame element 200 are jointed together by utilizing the first joint portion 130 and the second joint portion 230. A first rivet unit 110 is protruding at the first joint portion 130 and the second rivet hole 220 is penetrated through the second joint portion 230. The first rivet unit 110 of the first joint portion 130 is corresponding penetrating the second rivet hole 220 of the second joint portion 230 to fill the second rivet hole 220 so as to align and to joint the first frame element and the second frame element. Wherein, a combination thickness of the first joint portion 130 and the second joint portion 230 is equal to the thickness of the first frame element 100 and the second frame element 200. The second rivet hole 220 is an upside wide and downside narrow hole, such as a funnel type hole, and the first rivet unit 110 is penetrating the second rivet hole 220 from the narrow downside to the wide upside.

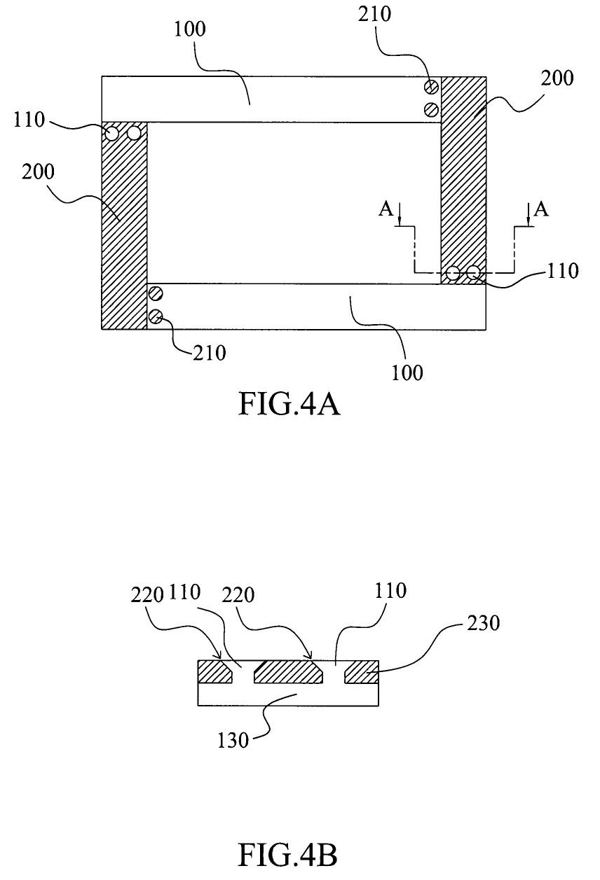

FIG. 4A is a front view schematic diagram of the one-piece-form bezel in accordance with one embodiment the present invention. In the present invention, the firs frame element 100 and the second frame element 200 are strip-type flat board to assemble the rectangular bezel. FIG. 4B is the cross-section view schematic diagram the according to FIG. 4A at the A-A cross-line. Such as shown in FIG. 4B, two first rivet unit 110 of the joint portion 130 are corresponding penetrating two second rivet holes 220 of the second joint portion 230 to fill second rivet holes 220 to align and joint the first frame element 100 and the second frame element 200.

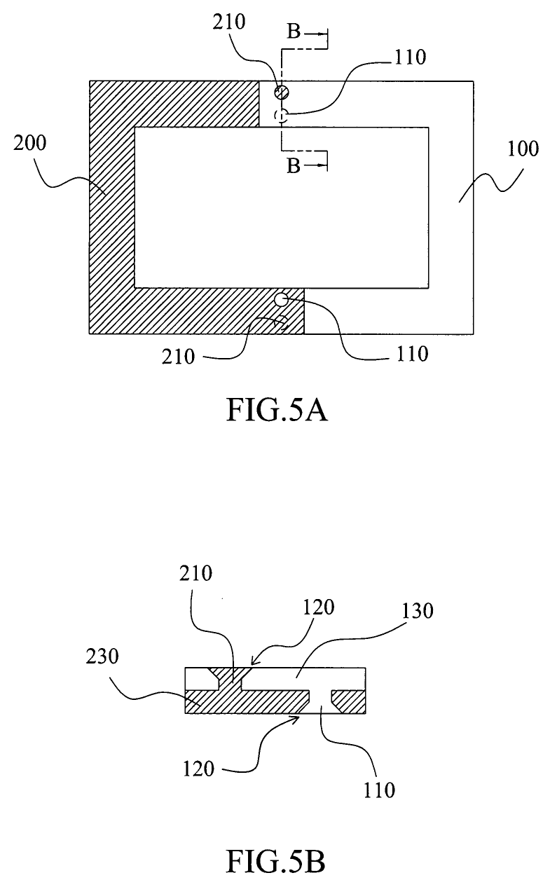

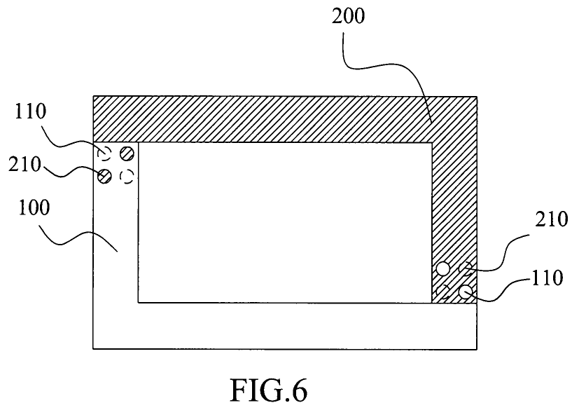

FIG. 5A is a front view schematic diagram of the one-piece-form bezel in accordance with one embodiment of the present invention. In the present invention, the first frame element 100 and the second frame element 200 are [symbol] -type flat board to assemble the rectangular bezel. FIG. 5B is the schematic diagram of the cross-section view according to FIG. 5A at the B-B cross-line. Such as shown in FIG. 5B, at the first joint portion 130, besides the first rivet unit 110 protruding arranged thereon, there can further arrange at least a first rivet hole 120 at the first joint portion 130 by utilizing the punching step. Correspondingly, at the corresponding position, at least a second rivet unit 210 at the second joint portion 230 by utilizing the forging step to corresponding penetrating the first rivet hole 120 and the first rivet unit 110 is penetrating the second rivet hole 220 so as the first frame element 100 and the second frame element 200 can be tightly align and joint with each other. Referring to FIG. 6, in another embodiment, the first frame element 100 and the second frame element 200 are L-type flat board to assemble the rectangular bezel and utilizes a plurality of first rivet holes 120 and first rivet unit 110 and a plurality of second rivet hole 220 and second rivet unit 210 to tightly align and joint with each other.

According to the above description, one feature of the present invention is to utilize different shape frame elements and arrange rivet unit and corresponding rivet hole at the edge of frame elements to tightly align and joint frame elements to form the one-piece-form bezel. The manufacturing procedure is simple and easy without any extra compound, such as the adhesive and frame-jointing element, and the bezel formed by the riveting step is stable and only need the original equipments.

To sum up the foregoing descriptions, the present bezel structure utilizes one-piece-form frame element having the rivet and one-piece-form frame element having the rivet hole to rivet each other and to utilize the punching step to complete the one-piece-form bezel. The present invention unnecessarily utilizes the conventional welding step, the solvent, the adhesive or the gluing step to joint frame elements and only utilizes the common punching equipments to complete the formulation of the one-piece-form bezel. While the size of the bezel become bigger to cause the difficult of the transporting, the design of the present one-piece-form bezel can deliver frame elements to the customer end and then perform the punching step and the joint step to assemble the one-piece-form bezel.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. A structure of a one-piece-form bezel, comprising:
at least a first frame element and at least a second frame element;
a first joint portion and at least a first rivet unit arranged at an edge of said first frame element; and
a second joint portion and at least a second rivet hole arranged at an edge of said second frame element, wherein
said first rivet unit is protruded on said first joint portion;
said second rivet hole is penetrated through said second joint portion;
said first rivet unit of said first joint portion is corresponding penetrating said second rivet hole of said second joint portion to fill said second rivet hole so as to align and joint said first frame element and said second frame element; and
a combination thickness of said first joint portion and said second joint portion is equal to the thickness of said first frame element and said second frame element.

2. The structure of a one-piece-form bezel according to claim 1, wherein said second rivet hole is a funnel type hole.

3. The structure of a one-piece-form bezel according to claim 1, wherein said second rivet hole is an upside wide and downside narrow hole.

4. The structure of a one-piece-form bezel according to claim 1, wherein said first joint portion is further arranged at least a first rivet hole thereon.

5. The structure of a one-piece-form bezel according to claim 4, wherein said second joint portion is further arranged at least a second rivet unit thereon penetrating said first rivet hole.

6. The structure of a one-piece-form bezel according to claim 1, wherein said first frame element and said second frame element are made of metal.

7. The structure of a one-piece-form bezel according to claim 1, wherein said first frame element and said second frame element is any one of a strip-type flat board, a L-type flat board or a [symbol] -type flat board.

8. A manufacturing method of a one-piece-form bezel, comprising the following steps:
providing at least a first frame element;
simultaneously forming a first portion and at least a first rivet unit at the edge of said first frame element, wherein said first rivet unit is protruded on said first joint portion;
providing at least a second frame element;
simultaneously forming a second joint portion and at least a second rivet hole at the edge of said second frame element, wherein said second rivet hole is penetrated through said second joint portion;
utilizing said first rivet unit of said first joint portion to corresponding penetrate said second rivet hole of said second joint portion to align and joint said first frame element and said second frame element; and
utilizing a punching step to punch said first rivet unit to fill said second rivet hole to tightly joint together with said first frame element and said second frame element.

9. The manufacturing method of a one-piece-form bezel according to claim 8, further comprising a step of utilizing a forging step to form said first joint portion and said first rivet unit.

10. The manufacturing method of a one-piece-form bezel according to claim 8, further comprising a step of utilizing a punching step to form said second rivet portion and said second rivet hole.

11. The manufacturing method of a one-piece-form bezel according to claim 8, further comprising a step of utilizing a punching step to form at least a first rivet hole at said first joint portion.

12. The manufacturing method of a one-piece-form bezel according to claim 11, further comprising a step of utilizing a forging step to form at least a second rivet unit at said second joint portion to corresponding penetrate said first rivet hole.

13. The manufacturing method of a one-piece-form bezel according to claim 8, wherein said first frame element and said second frame element are made of metal.

14. The manufacturing method of a one-piece-form bezel according to claim 8, wherein said first frame element and said second frame element can be any one of a strip-type flat board, a L-type flat board or a [symbol] -type flat board.

15. The manufacturing method of a one-piece-form bezel according to claim 8, wherein said second rivet hole is a funnel type hole.

16. The manufacturing method of a one-piece-form bezel according to claim 8, wherein said second rivet hole is an upside wide and downside narrow hole.
